(19) United States
(12) Patent Application Publication
(10) Pub. No.: US 2017/0140436 A1
(43) Pub. Date: May 18, 2017

(54) METHOD AND SYSTEM FOR EXPLORING CROWD SOURCED USER CURATED NATIVE ADVERTISEMENTS

(71) Applicant: EXCALIBUR IP, LLC, Sunnyvale, CA (US)

(72) Inventor: Hao Zheng, Saratoga, CA (US)

(21) Appl. No.: 14/436,194

(22) PCT Filed: Dec. 17, 2014
(86) PCT No.: PCT/CN2014/094109

§ 371 Date: Apr. 16, 2015

(51) Int. Cl. G06Q 30/02

(52) U.S. Cl. CPC G06Q 30/0269; G06Q 30/0252; G06Q 30/0242; G06Q 30/0214

(57) ABSTRACT

The present teaching relates to exploring user curated native advertisements. A request for an advertisement to be displayed to a user is first received. Based on the request and/or information related to the user, an advertisement is selected. Information about an event involving the user and with respect to the advertisement displayed to the user is received, based on which, an action to explore user curated native advertisements is initiated.

### BACKGROUND

Technical Field

The present teaching generally relates to advertising. More specifically, the present teaching relates to exploring sources of advertisement and utilization thereof.

Technical Background

In the age of the Internet, advertising is a main source of revenue for many Internet companies. Traditionally, providers of goods/services and/or advertising agencies provide advertisements to be displayed on different platforms. Limited by the cost of producing the advertisement and that of advertising, most advertisements are short but desire to deliver the right message to the audience. Despite the intent, a percentage of the audience viewing the advertisements may not quite understand the messages intended by the advertisement. In addition, because each advertisement is short, it sometimes cannot grab the attention of the viewers.

With the development of the Internet, more and more advertisements are offered via Internet applications. In addition, at the same time, the great advance that has been made to Internet-based social networks and increased level of communication in the Internet setting, the Internet has become a more and more dominant platform for advertising. Given the readily available platform to have two way communications, as compared with traditional platforms for advertising, it has become more and more common to measure the effectiveness of the advertising via the Internet communications and utilize that information to enhance the effectiveness of online advertising.

However, such advancement does not change the facts associated with the high cost in producing advertisements and lack of diversity in form and content of advertising in order to appeal to a wider range of audience. Thus, there is a need for an advertising scheme that (1) is less expensive yet with more diversified sources, (2) yields better appeal to a wider range of audience, (3) provides richer content, and (4) presents the flexibility in choosing versions of the same advertisement for different audience in a way that creates improved affinity between the advertisement and the viewers of the advertisement. The present teaching aims to address those issues.

### SUMMARY

The teachings disclosed herein relate to methods, systems, and programming for advertising. More particularly, the present teaching relates to methods, systems, and programming related to exploring sources of advertisement and utilization thereof.

In one example, a method, implemented on a machine having at least one processor, storage, and a communication platform capable of connecting to a network for providing an advertisement is disclosed. Via a communication platform, a request for an advertisement to be displayed to a user is received. Based on the request, an enhanced advertisement server obtains an advertisement selected from a plurality of advertisements in accordance with the request and/or information related to the user. When information about an event, which involves the user and with respect to the selected advertisement that has been displayed to the user, is received, the enhanced advertisement server initiates, based on the information about the event, an action to explore user curated native advertisements.

In a different example, a system for providing an advertisement is disclosed, which includes an enhanced ad selection controller connecting to a network and configured for receiving via the network a request for an advertisement to be displayed to a user, a selector coupled with the enhanced ad selection controller and configured for obtaining an advertisement selected from a plurality of advertisements in accordance with the request, and a user curated native ad explorer, coupled with the enhanced ad selection controller and configured for receiving information about an event involving the user and with respect to the selected advertisement after being displayed to the user and initiating an action to explore user curated native advertisement based on the information about an event.

Other concepts relate to software for implementing the present teaching on exploring user curated native advertisements. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having data recorded thereon for providing an advertisement, wherein the medium, when read by the machine, causes the machine to perform a series of steps, including, receiving, via a communication platform, a request for an advertisement to be displayed to a user, obtaining an advertisement selected from a plurality of advertisements based the request and/or information related to the user, receiving information about an event involving the user and with respect to the advertisement that has been displayed to the user, and initiating an action to explore at least one user curated native advertisement based on the received information about an event.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1-2 illustrate exemplary system configurations in which an enhanced ad server can be deployed in accordance with various embodiments of the present teaching;

FIG. 3 illustrates a high level system diagram of an enhanced ad server, according to an embodiment of the present teaching;

FIG. 4 illustrates yet another exemplary system configuration in which an ad selector and a user curated native ad based enhancer can be deployed, according to an embodiment of the present teaching;

FIG. 5 is a flowchart of an exemplary process for an enhanced ad server, according to an embodiment of the present teaching;

FIG. 6 depicts a high level system diagram of a user curated native ad explorer, according to an embodiment of the present teaching;

FIG. 7 is a flowchart of an exemplary process for exploring user curated native ads, according to an embodiment of the present teaching;

FIG. 8 depicts an exemplary high level system diagram of a user native ad curator, according to an embodiment of the present teaching;

FIG. 9 is a flowchart of an exemplary process of a user native ad curator, according to an embodiment of the present teaching;

FIG. 10 depicts an exemplary high level system diagram of a user native ad selector, according to an embodiment of the present teaching;

FIG. 11 is a flowchart of an exemplary process of a user native ad selector, according to an embodiment of the present teaching;

FIG. 12 depicts an exemplary high level system diagram of a user native ad performance evaluator, according to an embodiment of the present teaching;

FIG. 13 shows an exemplary data structure for archiving user native ads with performance information recorded therein, according to an embodiment of the present teaching;

FIG. 14 is a flowchart of an exemplary process of a user native ad performance evaluator, according to an embodiment of the present teaching;

FIG. 15 depicts an exemplary high level system diagram of a user incentive allocator, according to an embodiment of the present teaching;

FIG. 16 is a flowchart of an exemplary process of a user incentive allocator, according to an embodiment of the present teaching;

FIG. 17 depicts the architecture of a mobile device which can be used to implement a specialized system incorporating the present teaching; and

FIG. 18 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, medium, and other implementations directed to enhancing advertisement serving by exploring user curated native advertisements (or generally referred to herein as “enhanced ad serving”) realized as a specialized and networked system by utilizing one or more computing devices (e.g., mobile phone, personal computer, etc.) and network communications (wired or wireless). The disclosed teaching on enhanced ad serving includes, but not limited to, an online process and system that in situations where an original ad is displayed to a user, a user native ad associated with the original ad may be solicited from the user and stored in connection with the original ad. During the solicitation, the user is asked to provide a description of the original ad as to what the original ad is about. For each original ad, more than one user native ads may be solicited and stored in association with the original ad. Solicitation of user curated ads may be triggered by certain user action performed with respect to the original ad such as an indication of interest of the user in the displayed original ad. Such an indication may be reflected through some user events such as moving the cursor to the displayed original ad.

During ad serving, when an original ad is considered appropriate to be displayed to a user, a user curated native ad associated with the original ad may be served, either in place of or together with the original ad. Serving an associated user curated native ad may be elected opportunistically or according to other schemes. The use of a user curated native ad is recorded and the performance of the user curated native ad is assessed based on the reaction of the user on the displayed user curated native ad. Based on the performance of a user curated native ad, future performance of the user curated native ad can be evaluated and/or predicted to facilitate future selection of the user curated native ads.

To encourage and incentivize users who attributed quality user curated native ads and/or whose native ads have achieved good performance, the system and process according to the present teaching may provide incentives to users who attributed user curated native ads that are acceptable quality and have shown to perform well. Providing user curated native ads to users may enhance the sources of ad descriptions, improve the overall effectiveness of the original ads, as well as the user experience.

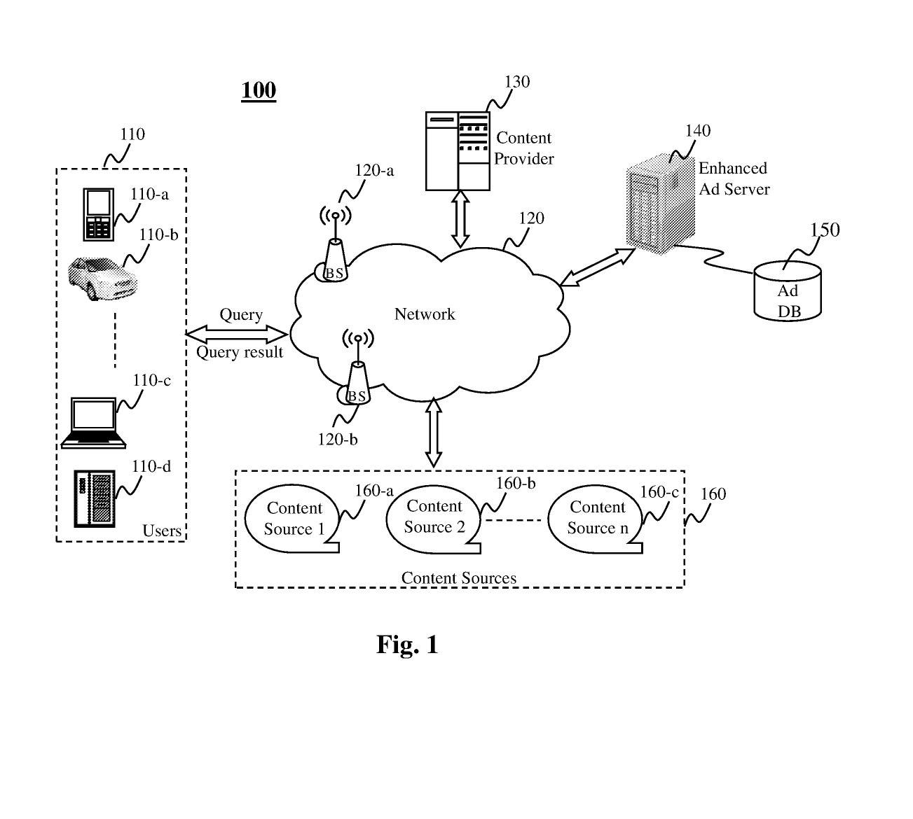

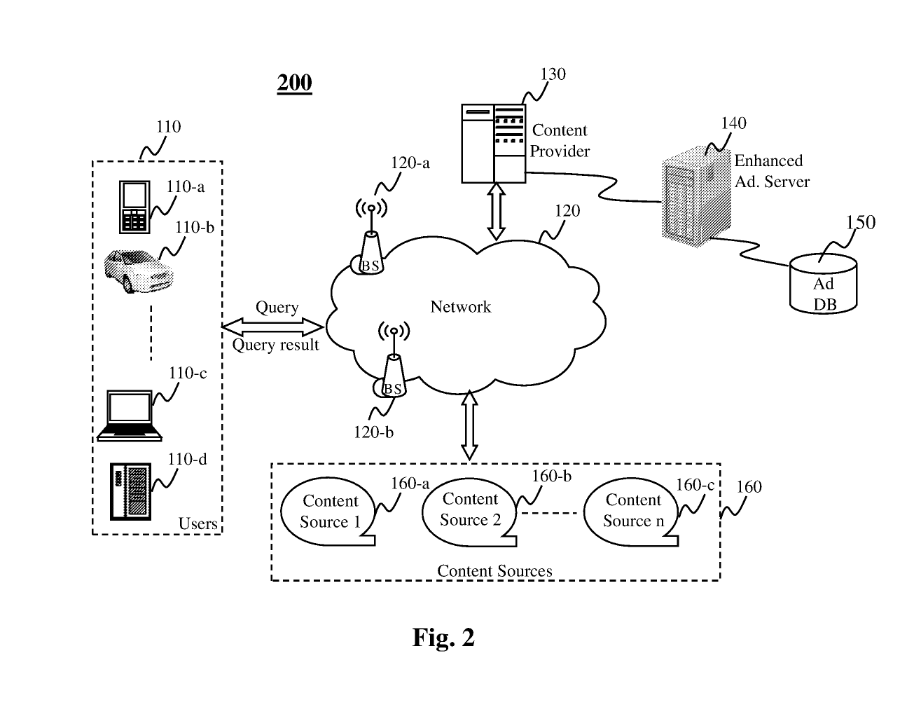

FIGS. 1-2 illustrate exemplary system configurations in which an enhanced ad server 140 can be deployed in accordance with various embodiments of the present teaching. In FIG. 1, the exemplary system 100 includes users 110, a network 120, one or more publisher portals or content providers 130, content sources 160 including content source 1 160-a, content source 2 160-b, . . . , content source n 160-c, an enhanced ad server 140, and a system operator/administrator 180.

The network 120 may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a virtual network, or any combination thereof. A network may also include various network access points, e.g., wired or wireless access points such as base stations or Internet exchange points 120-a, . . . , 120-b, through which a data source may connect to the network 120 in order to transmit information via the network and a network node may connect to the network 120 in order to receive information. In one embodiment, the network 120 may be an online advertising network or an ad network, which connects enhanced ad server 140 to content provider 130 or websites/mobile applications that desire to host or receive advertisements. The content provider 130 can be a publisher, a search engine, a content portal, or any other sources from which content can be obtained. Functions of an ad network include an aggregation of ad-space supply from content provider 130 and ad supply from the enhanced ad server that provides, on demand, an advertisement matching with the ad-space and/or content surrounding the ad-space. An ad network may be a television ad network, a print ad network, an online (Internet) ad network, or a mobile ad network.

Users 110 may be of different types such as users connected to the network via desktop connections (110-d), users connecting to the network 120 via wireless connections such as through a laptop (110-c), a handheld device (110-a), or a built-in device in a mobile vehicle such as a motor vehicle (110-b). In one embodiment, user(s) 110 may be connected to the network 120 and able to access and interact with online content with ads (provided by the content provider 130), via wired or wireless means, through related operating systems and/or interfaces implemented within user-wearable devices (e.g., glasses, wrist watch, etc.).

A user, e.g., 110-1, may send a request or a search query for online content to the content provider 130 and receive content as well as one or more ads (identified by the enhanced ad server 140) via the network 120. The online content and ads may be provided and rendered on the user device. The user 110-1 may interact with the rendered content and/or ads by, e.g., clicking, dwelling, or hovering on/over the content and/or ads. Some user interactions may reflect the user's reaction to the content/ads displayed. For example, the user may click on an ad displayed which may ultimately lead to a click through or conversion, i.e., a purchase made on the product/service advertised. As another example, the dwell time that the user spent on a display ad (e.g., detected by computing the length of time during which the cursor dwells on the ad) may indicate that the user is interested in the content of the ad, i.e., the product/service being advertised. In the context of the present teaching, such user interaction related to the ads on display may be observed and used to explore user curated native ad sources and subsequently provide diversified sources of ads to enhance the effectiveness of advertisement and user experience.

In some embodiments, as will be described in further detail below, the enhanced ad serving techniques based on user curated native ads as described herein include processing data related to a user 110 and a device that the user 110 is using to access the online content. Such user data may include user device IP address, user geographical location, type of user device (mobile phone, tablet computer, laptop, etc.), user log-in, and/or account information such as user demographics, preferences, and/or other user- or user-device-related data. Such user data may be accessed by the enhanced ad server 140 from different sources, e.g., directly, from the content provider 130 which is providing the online content being displayed to the user 110, and/or from another database (not shown) that is configured to collect and store such user data.

Content provider 130, may correspond to an entity, whether an individual, a firm, or an organization, publishing or supplying content, including a blogger, television station, a newspaper issuer, a web page host, a content portal, an online service provider, or a game server. For example, in connection to an online or mobile ad network, content provider 130 may be an organization such as USPTO.gov and CNN.com, a content portal such as YouTube and Yahoo.com, or a content-soliciting/feeding source such as Twitter or blogs. In one example, the content sent to user 110-1 may be generated or formatted by the content provider 130 based on data provided by or retrieved from the content sources 160. A content source may correspond to an entity where the content was originally generated and/or stored. For example, a novel may be originally printed in a magazine, but then posted online at a web site controlled by a publisher.

For a given online session in which a user 110 is to access online content provided by a content provider 130, the online content may be presented and rendered on the user device with one or more advertisements. The number of ads may depend on the number of ad-space present in the online content. For each ad-space, the content provider 130 requests an ad from the enhanced ad server 140 and the ad selected by the enhanced ad server 140 is to be rendered in the ad-space intended. With the selected ad for each ad-space, the content provider 130 sends the online content with the corresponding selected ads to the user so that the online content can be rendered with the selected ads rendered therein to the user 110.

In requesting an ad to be displayed to the user with the online content, the content provider 130 may provide context information related to the online content and/or the user requesting the online content to the enhanced ad server 140 so that an ad appropriate for the online content and/or the user may be determined. On the other hand, user events corresponding to, e.g., user interactions associated with the ads displayed to the user, may also be provided to the enhanced ad server 140 so that such feedback information may be used in exploring user curated native ads to further improve the performance.

The enhanced ad server 140, generally, may correspond to an entity that provides an appropriate ad to the content provider 130 when it is requested. The enhanced ad server 140 can be an entity that provides product(s) and/or service(s), and itself handles the advertising process for its own products) and/or a service (e.g., websites, mobile applications, etc.) related to advertising, or a combination thereof. The enhanced ad server as a service may include an advertising agency or a dealer of advertisement that operates a platform that connects an advertiser or advertising agency with the content provider 130.

The enhanced ad server 140 may provide an ad based on an ad database 150, which store ads from a plurality of sources, and user curated native ads generated and maintained by the enhanced ad server 140. An ad provided by the enhanced ad server 140 may have different forms, including streaming content, static content, sponsored content, or any combination thereof. Static content may include text, image, audio, or any rich media combination thereof. Content of an ad selected by the enhanced ad server 140 may be placed at any location appropriate on a content page or mobile app, and may be presented both as part of a content stream as well as a standalone advertisement, rendered strategically around or within the content stream. In some embodiments, the enhanced ad server 140 may include or may be configured as an ad exchange engine that serves as a platform for buying one or more advertisement opportunities made available by a content provider (e.g., publisher 130). The ad exchange engine may solicit biddings among multiple advertisers associated with the ad exchange engine, and submit a suitable bid to the content provider 130, after receiving and in response to a bid request from the content provider 130.

The content sources 160 may correspond to an online content/app generator, including a publisher (e.g., CNN.com), whether an individual, a business, or a content collection agency such as Twitter, Facebook, or blogs. Content sources 160 may be any source of online content such as online news, published papers, blogs, on-line tabloids, magazines, audio content, image content, and video content. It may also be a content portal presenting content originated from a content provider and examples of such content portals include Yahoo! Finance, Yahoo! Sports, AOL, and ESPN. The content from content sources 160 includes multi-media content or text or any other form of content comprised of website content, social media content, such as Facebook, Twitter, Reddit, etc., or any other content originator. It may be licensed content from providers such as AP and Reuters. It may also be content crawled and indexed from various sources on the Internet. Content sources 160 provide a vast array of content to content provider 130 and/or other parts of system 100.

In some embodiments, the ad database 150, which may be centralized or distributed, archives data related to a plurality of ads originated from one or more sources. Each ad may be stored with some textual information related to the ad, including a description of what the ad is about as well as additional information such as intended audience of the ad indicated via, e.g., demographics of the intended audience, geographical locations where the ad is to be displayed, and/or time frame(s) the ad is to be presented to the intended audience. The enhanced ad server 140 is coupled with the ad database 150 so that when a request is received from the content provider 130 for an ad, the enhanced ad server 140 selects an ad appropriate for the request and returns it to the content provider 130. The selected ad may be from the ad database 150 and a user curated native ad associated with the selected ad from the ad database 150 may also be provided to enhance the user experience or improve the effectiveness of the selected ad.

FIG. 1 shows a system configuration in which the enhanced ad server 140 serves as an independent service in relation to the content provider 130. In this configuration, the enhanced ad server 140 can be connected to a plurality of content providers and facilitates ad serving as a service to any content provider that requests an ad to be displayed with certain online content with ad inserted therein to a user. FIG. 2 presents a slightly different system configuration 200 in which the enhanced ad server 140 is coupled to the content provider 130 as a backend sub-system. In this configuration, the enhanced ad server 140 as shown is used only by the content provider 130 in operation.

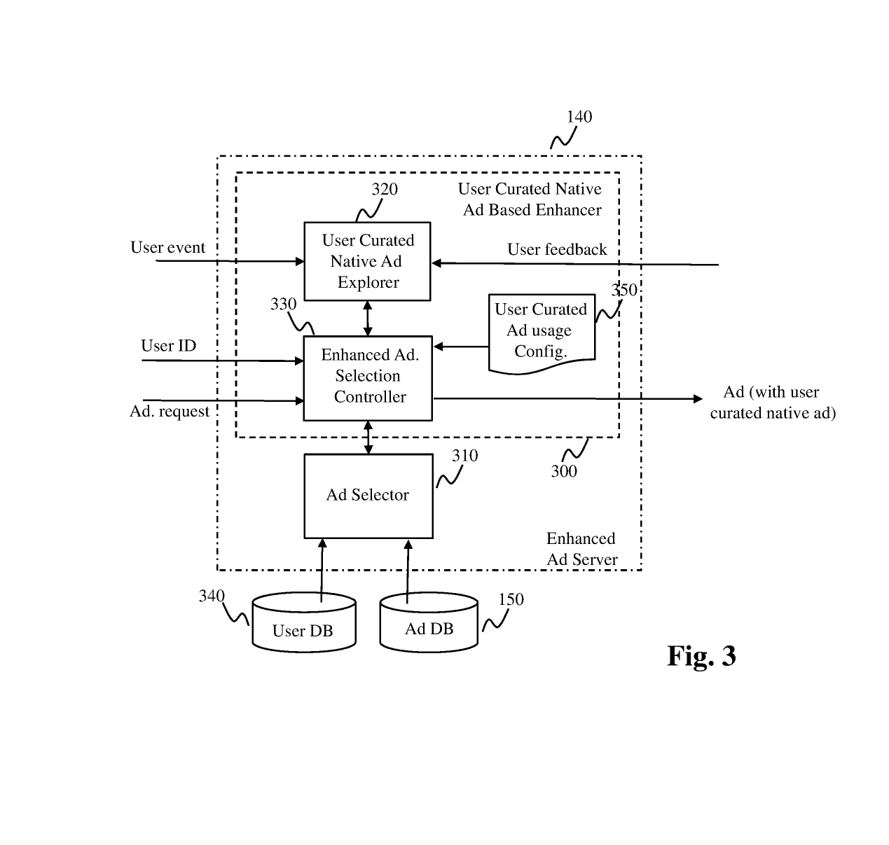

FIG. 3 illustrates depicts a high level system diagram of the enhanced ad server 140, according to an embodiment of the present teaching. The exemplary system diagram of the enhanced ad server 140 comprises a user curated native ad based enhancer 300 and an ad selector 310. In operation, the user curated native ad based enhancer 300 takes an ad request from the content provider 130 as input. In another example, the user curated native ad based enhancer 300 may also receive contextual information, e.g., together with the ad request, related to, e.g., related to a user to whom the requested ad is to be displayed and/or the online content in which the requested ad is to be inserted and displayed to the user. The user curated native ad based enhancer 300 controls the selection of an ad appropriate for the user in response to the ad request and comprises an enhanced ad selection controller 330 and a user curated native ad explorer 320.

In operation, the enhanced ad selection controller 330 receives a request with possibly additional contextual information, e.g., information related to the user who requests the online content and/or information related to the context of the online content. The request for an ad can be from the content provider 130 or an ad exchange mechanism (not shown). The request may be associated with a web page in which the requested ad is to be inserted. The contextual information received at the enhanced ad selection controller 330 may include information about the user to whom the web page incorporating the requested ad is to be displayed and/or information related to the content of the web page (not shown). Such contextual information may be used in determining when to use user curated native ads and which ad (either the original ad or a user curated native ad) is appropriate.

Upon receiving the request for an ad, the user curated native ad based enhancer 300 initiates to select an ad appropriate in light of the contextual information. It may activate the ad selector 310 to select an original ad from the ad database 150 that is appropriate with respect to the ad request. The original ad is provided by an advertiser or an advertising agency in its original form, which may include the presentation data, target data, and/or a textual description of what the ad is about. The presentation of the original ad may be video, imagery, sound, or a combination thereof in the form of rich media content. The original ad is different from a user curated native ad in the sense that there is no user provided content or information in the original ad.

Once invoked, the ad selector 310 may perform functions similar to a conventional ad server which takes an ad request and selects an original ad that is deemed suitable from the ad database 150. The ad selector 310 may also determine an ad based on information related to the user who requests the online content from the content provider 130. For example, in FIG. 3, the ad selector 310 may access information from a user database 340 to access data on, e.g., user's demographics, preferences, past history on reaction to ads, etc. Such user information may be used to determine whether the user meets the criteria for the target audience specified, e.g., in each original ad being considered. In some embodiments, the ad selector 310 may also check whether the content of the online content to be provided to the user matches with the content of the ad to be considered for selection. In general, the ad selector 310 may utilize any existing and future developed technologies in ad selection, without affecting the scope of the present teaching.

To utilize user curated native ads to enhance the performance of ad serving and/or user experience, the user curated native ad based enhancer 300 also explores to use user curated native ads. In the illustrated embodiment, the enhanced ad selection controller 330 may invoke a user curated native ad explorer 320 to select appropriate user curated native ad to be served together with or in place of the original ad. The decision on when to explore user curated native ads may be made based on some pre-determined configuration specified in a user curated ad usage configuration 350 which may be dynamically configured based on needs. In some embodiments, an opportunistic configuration may be set so that the enhanced ad selection controller 330 may opportunistically determines that user curated native ad is to be used to enhance the ad serving. In other embodiments, a scheduled configuration may be used so that a user curated native ad is regularly used. In yet other embodiments, the use of a user curated native ad may be invoked based on a model. The model may be controlled by dynamic information as parameters.

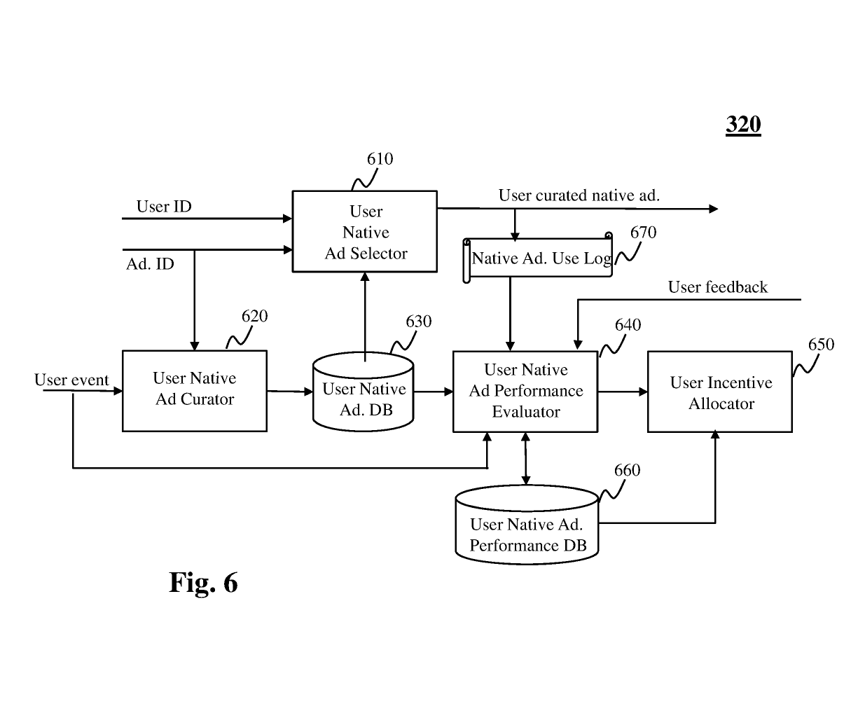

If a decision is made to explore the use of a user curated native ad, the enhanced ad selection controller 330 activates the user curated native ad explorer 320 by providing, e.g., information related to the original ad selected by the ad selector 310 and possibly the user information or content information, to the user curated native ad explorer 320. The determination of a user curated native ad appropriate for the selected original ad is made by the user curated native ad explorer 320. The determined user curated native ad is then returned from the user curated native ad explorer 320 to the enhanced ad selection controller 330. The user curated native ad explorer 320 not only selects an appropriate user curated native ad given an original ad and the contextual information, it also performs other functions associated with exploration of user curated native ads. Details about the user curated native ad explorer will be described in more detail in regard to FIGS. 6-16.

Upon receiving the selected user curated native ad, the enhanced ad selection controller 330 determines how to serve the ad to respond to the ad request. In some embodiments, the original ad selected is served together with the user curated native ad to enhance the description of the original ad based on the native ad curated from a user. In some embodiments, a choice is made as to which ad, the original ad or the user curated native ad, is to be used to serve the user. The choice may be made based on a variety of considerations. For example, whether the textual description of the original ad needs to be supplemented, whether the device on which the ad is to be displayed has a certain limitation on the size of the ad-space, or whether there is a limitation on the bandwidth on the user's service, etc.

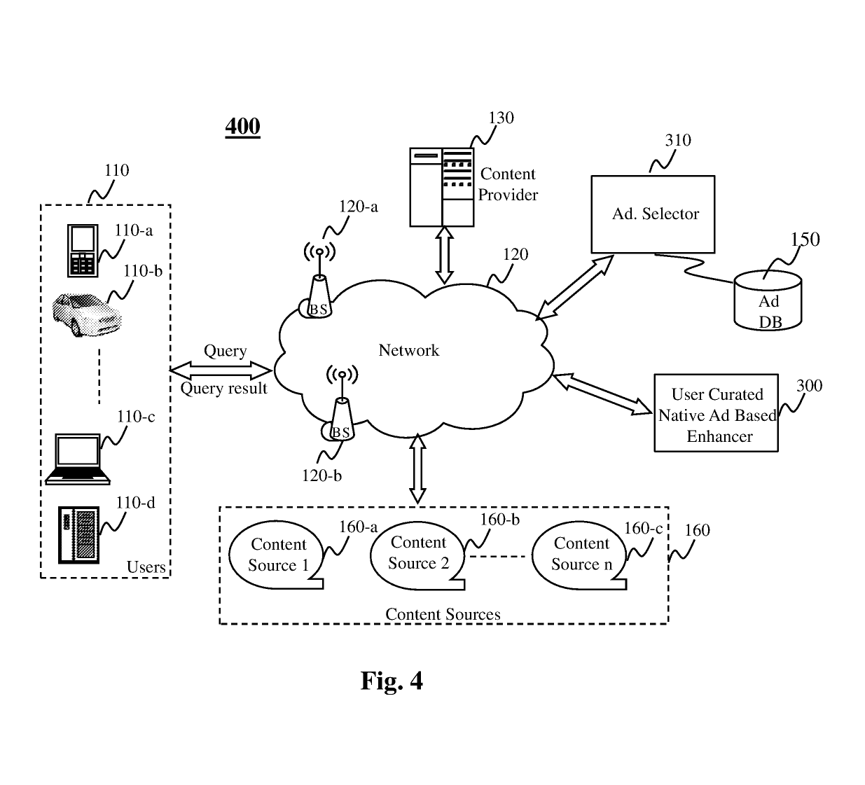

The user curated native ad based enhancer 300 and the ad selector 310 as depicted in FIG. 3 may also be implemented separately and deployed independently on the network. This is shown in FIG. 4, which illustrates yet another exemplary system configuration 400 in which the ad selector 310 and the user curated native ad based enhancer 300 can be deployed as independent service providers on the network, according to an embodiment of the present teaching. As can be seen, the ad selector 310 is separately connected to the network as the user curated native ad based enhancer 300. Although separately deployed as independent services, for the purposes of this present teaching, they together perform the functions related to enhancing ad serving based on user curated native ads as described herein.

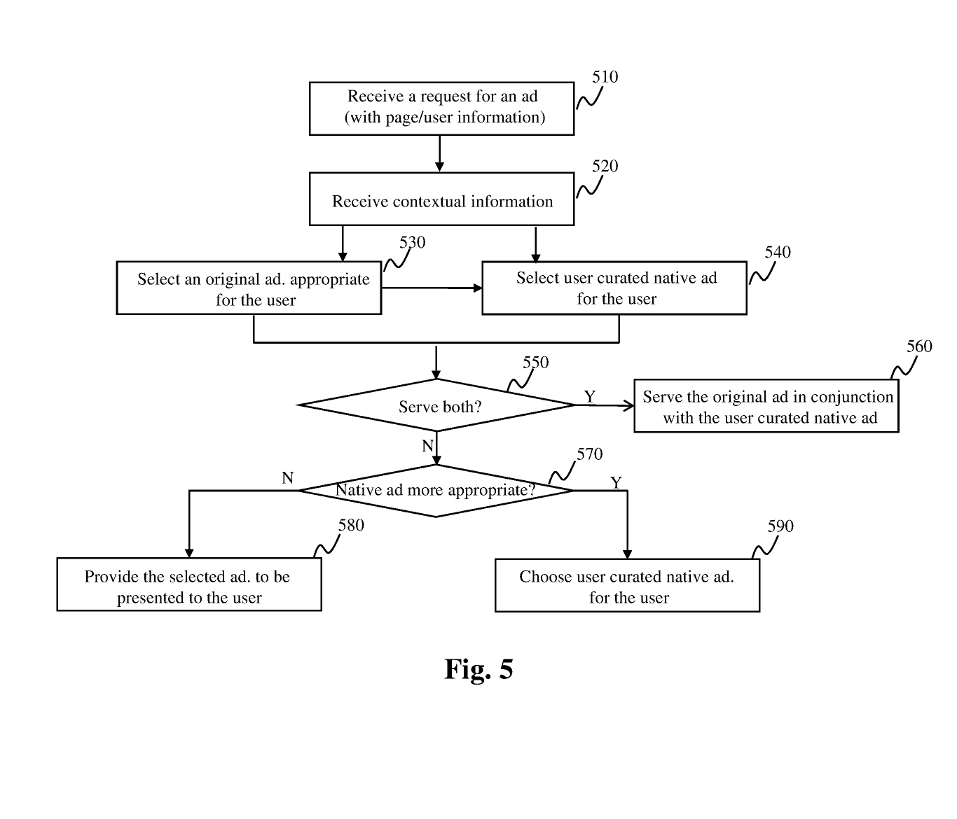

FIG. 5 is a flowchart of an exemplary process for the enhanced ad server 140, according to an embodiment of the present teaching. A request for an ad is first received at 510. Optionally, contextual information such as information related to the content of the page and/or information related to the user is received with the request at 520. Based on the request and the contextual information, an original ad is selected at 530. When a user curated native ad is to be used to enhance the ad serving, a user curated native ad appropriate for the selected original ad is selected at 540. With both the original ad and the user curated native ad being selected, the user curated native ad based enhancer 300 determines, at 550, whether both will be served n connection with each other. If both will be served, they are served together at 560. If only one is to be served, it is determined, at 570, whether the user curated native ad is more appropriate to serve than the original ad. If the original ad is considered better, the original ad is served at 580. If the user curated native ad is considered better, the selected user curated native ad is served at 590.

FIG. 6 depicts a high level system diagram of the user curated native ad explorer 320, according to an embodiment of the present teaching. As mentioned earlier, the user curated native ad explorer 320 not only selects a user curated native ad appropriate for the original ad, it also performs other functions necessary to facilitate enhanced ad serving via user curated native ads, including curating user native ads when appropriate, logging the use of user curated native ads to enable performance evaluation of user curated ads, as well as providing incentives to users who attributed native ads that yield good performance in ad serving. The embodiment of the user curated native ad explorer 320, as illustrated in FIG. 6, comprises a user native ad curator 620, a user native ad selector 610, a user native ad performance evaluator 640, and a user incentive allocator 650. Each of the functional blocks in FIG. 6 facilitates the user curated native ad exploration from a different perspective.

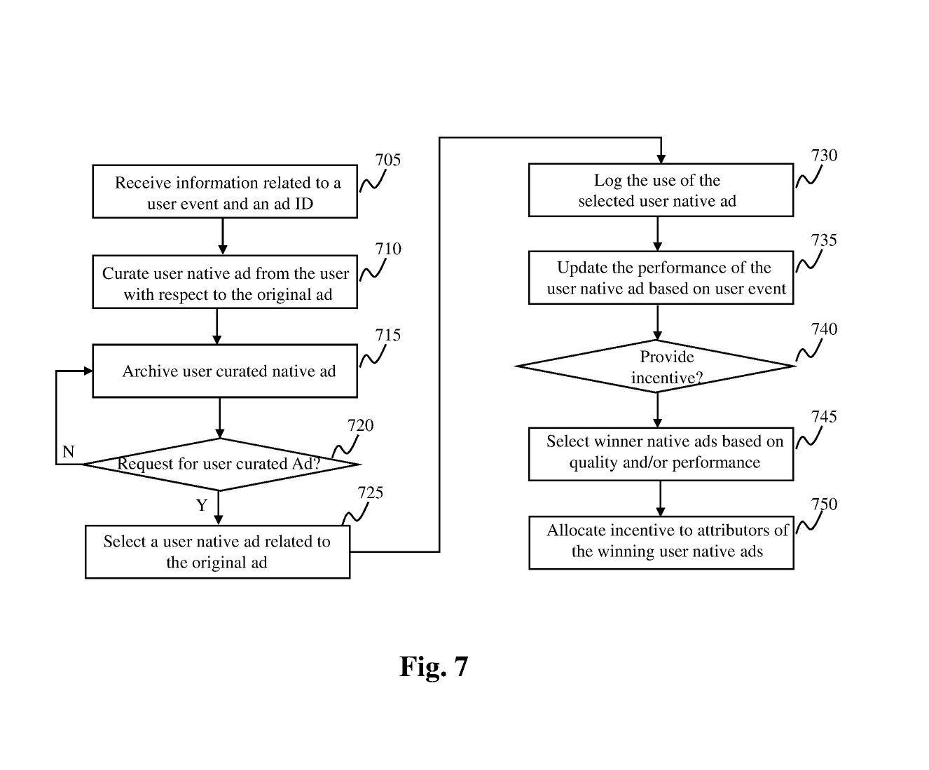

FIG. 7 is a high level flowchart of an exemplary process of the user curated native ad explorer 320, according to an embodiment of the present teaching. To facilitate user curated native ad exploration, the user curated native ad explorer 320 first curates one or more user native ads with respect to some original ads. Upon receiving information, at 705, related to an original ad, the user native ad curator 620 solicits, at 710, a user native ad. The received information may also include a user event that serves as a triggering event to initiate the curation. The received original ad serves as the basis for the solicitation because the curated native ad is with respect to an existing ad and the user native ad provides a more detailed or more user perspective oriented description of what the original ad is about. The curated user native ad is then stored at 715 in a user native ad database 630 (FIG. 6) for future use.

Once there are user curated native ads archived, they can be used or explored to enhance ad serving. When a request for a user curated native ad (related to an original ad) is received, determined at 720, a user native ad is selected, at 725, that is appropriate for the original ad. The use of this selected user curated native ad is then logged at 730 in a native ad use log 670 (FIG. 6). Based on the logged information related to the use of the selected user curated native ad, the performance of the selected user native ad is updated at 735. For example, the frequency of the use of this user native ad may be updated. The evaluation may also be triggered by a user event, e.g., the user who viewed the user native ad clicked on the ad or the click ultimately led to conversion. The updated information about the usage of a user native ad and its effect on a user may be the basis for predicting future performance of the user native ad. Such prediction may also be used in the future in selecting a user native ad. Both performance of the native ads and the prediction about their future performance may be stored in a user native ad performance database 660 (FIG. 6).

To encourage users to enter their native ads, the system and method as described herein may also provide mechanisms by which users who attributed high quality user native ads and/or native ads that yield good return may be incentivized. When incentives are to be provided, determined at 740, the winning user native ads are selected based on their quality and/or the performance at 745. The attributors of such winning user native ads are then rewarded at 750 based on selected incentives.

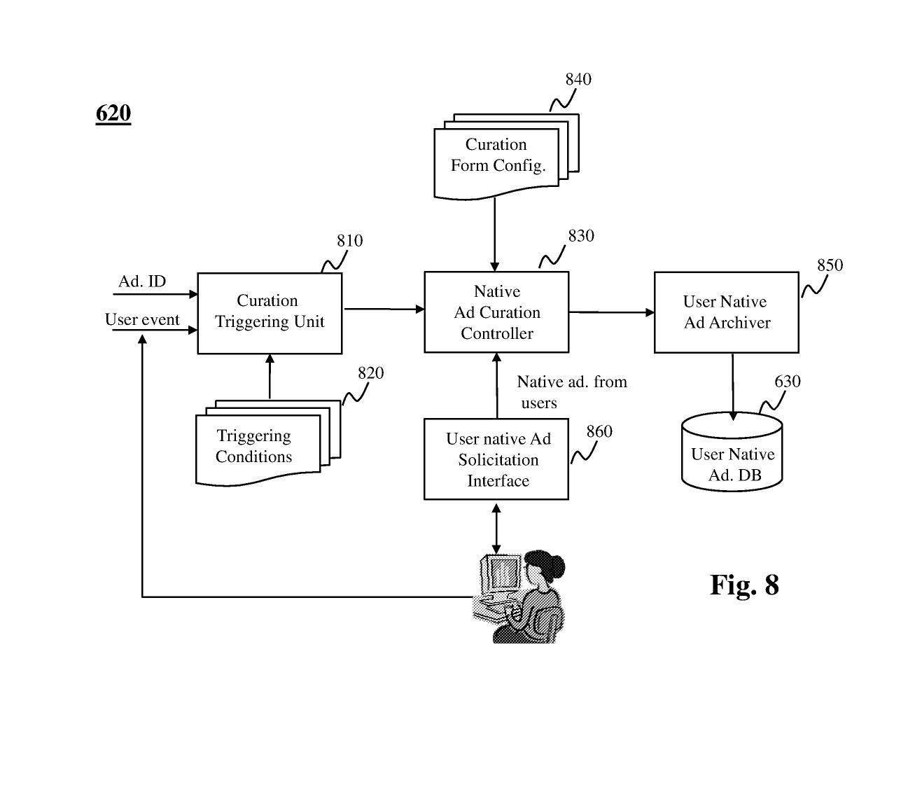

FIG. 8 depicts an exemplary high level system diagram of the user native ad curator 620, according to an embodiment of the present teaching. As described above, the user native ad curator 620 is for gathering native ads from various users. The act of gather may be triggered when certain conditions are met. In this illustrated embodiment, the user native ad curator 620 comprises a curation triggering unit 810, a native ad curation controller 830, a user native ad solicitation interface 860, and a user native ad archiver 850. In operation, when there is a user event, e.g., an action performed with respect to an original ad displayed to a user, information related to the user event and the corresponding identifier of the original ad are sent to the user native ad curator 620. The curation triggering unit 810 receives the information related to a user event and determines whether it is a triggering event for curating user native ad from the user. To do so, the curation triggering unit 810 analyzes the user event with respect to the original ad and decides, based on some triggering conditions 820, whether the user event satisfies at least some of the triggering events configured. Such a triggering condition can be, e.g., having a cursor mouse over (hovering) the original ad where it is displayed, clicking on the original ad, clicking through the original ad and returning to the web page, or a conversion event. Each original ad may be configured with its own defined triggering event in some embodiments.

When the user event meets the triggering event with respect to the original ad, the curation triggering unit 810 triggers the user native ad curation process. It does so by, e.g., invoking the native ad curation controller 830, which then activates the user native ad solicitation interface 860 according to the curation form configuration 840. The curation form configuration 840 specifies some forms in which the user curated native ads can be solicited. For example, the curation form can be a text input box or window presented separately from the web page displayed. It can also be specified as in an interstitial page after a user click or after the user returns to the content page after a click-through or on the original ad landing page or a separate feedback page after a user conversion. The curation form configuration 840 may be re-configured dynamically based on needs. Once changed, the native ad curation controller 830 may be configured to follow what is specified in the curation form configuration 840 in soliciting the user native ads.

Through the user native ad solicitation interface 860, the native ad curation controller 830 gathers the input from the user as native ad and sends it to the user native ad archiver 850 so that the solicited user native ads can be archived. Each user native ad solicited with respect to an original ad may be archived in a way with, e.g., an index that is indicative of the association with the original ad stored in the ad database 150. Any form of the indication of the association is operable to achieve the same.

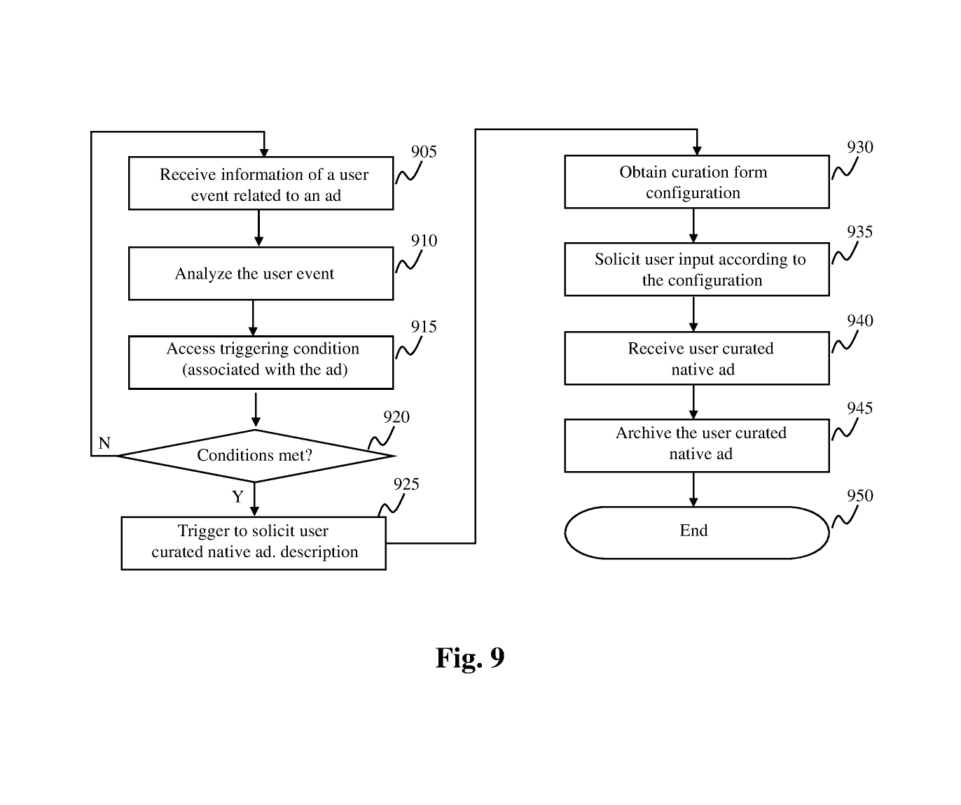

FIG. 9 is a flowchart of an exemplary process of the user native ad curator 620, according to an embodiment of the present teaching. First, information related to a user event and the corresponding original ad with respect to which the user event is performed is received at 905 and analyzed at 910. The analyzed user event information is checked, at 915, against pre-stored triggering conditions that dictate when a user native ad is to be curated. If relevant condition(s) is not met, determined at 920, the process goes back to 905 to wait to receive information on the next user event. If relevant condition(s) is met, the user native ad curator 620 triggers, at 925, the process of soliciting user native ad with respect to the corresponding original ad. To do so, the native ad curation controller 830 obtains, at 930, pre-stored configurations as to the form in which the user native ad is to be solicited. User native ad related to the original ad is then solicited, at 935, according to the obtained curation form configuration. Input from the user who performs the user event is then received, at 940. Although the input from the user may commonly be text, other forms of input can also be solicited and received. Examples include audio, video, or other types of rich media content provided as a user curated native ad. The received user native ad is then archived at 945 in connection with the original ad. The association between the user native ad and the origin ad facilitates the future retrieval of the same user curated native ad when the original ad is selected again for a user.

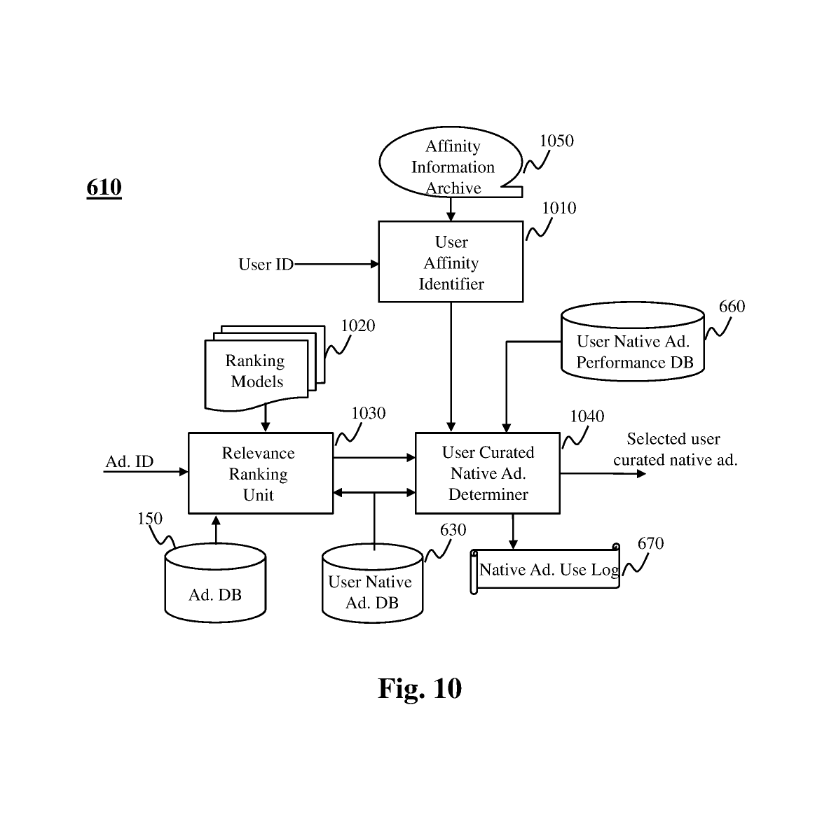

FIG. 10 depicts an exemplary high level system diagram of the user native ad selector 610, according to an embodiment of the present teaching. The user native ad selector 610 is for determining, from one or more user curated native ads associated with an original ad, a specific user curated native ad that is considered to be suitable with respect to the original ad and the user to whom the original ad is to be displayed. In this illustrated embodiment, the user native ad selector 610 comprises a relevance ranking unit 1030, a user affinity identifier 1010, and a user curated native ad determiner 1040. In operation, when the user native ad selector 610 receives a request to select a user curated native ad associated with a particular original ad, the relevance ranking unit 1030 retrieves user curated native ads stored in the user native ad database 630 that are associated with the particular original ad. For each of such retrieved user curated native ad, the relevance ranking unit 1030 assesses the relevance between the particular original ad and the retrieved user curated native ad. The relevance may be assessed based on linguistic criteria when the user curated native ad is text based. Algorithms developed and to be developed to measure the semantic similarity between two pieces of textual content may be deployed for assessing the relevance. When the user native ad is in other modality such as visual or audio, algorithms developed and to be developed in evaluating the similarity between two pieces of information in those related modalities may also be adopted to achieve the evaluation.

The relevance between the particular original ad and each of the user curated native ads retrieved from the user native ad database 630 may then be ranked, e.g., in a descending order, based on ranking models 1020. Such an ordered result may then be sent from the relevance ranking unit 1030 to the user curated native ad determiner 1040. To select a suitable user curated native ad, the user curated native ad determiner 1040 may consider the relevance between the particular original ad and each candidate user curated native ad. Each of the associated user curated native ads retrieved may be attributed by an attributor. The affinity between the current user to whom the particular original ad and/or a selected associated user curated native ad is/are to be displayed may be appropriately considered in determining the selected associated user curated native ad. That is, the social affinity between the current user and the attributors of curated user native ads can be used as a factor in selecting appropriate user curated ads. For example, the higher the social affinity between the current user and the attributors of native ads, the more likely the user native ads contributed by such attributors will be selected and presented to the current user.

The affinity may not be limited to just social affinity. The concept of affinity, according to the present teaching, may also encompass closeness in other dimensions, e.g., affinity in terms of demographics, affinity in terms of particular interests/preferences, affinity in terms of physical space/time such as geographical regions and the time of the query, etc. Affinity in any of such dimensions between the current user and an attributor of a native ad may be indicative of affinity in behavior, particular in how they will be perceptive to the content of the native ad and how they will behave or react to the native ad. For example, shared interests between the current user and an attributor of a native ad may indicate that they will be both interested in a certain way of describing a product/service to be advertised. The fact that the current user lives in the same geographical region as an attributor of a native ad may increase the likelihood that the current user will be interested in the native ad because the attributor may provide content in the native ad in a way that is more attractive to people living in that particular locale. The fact that the current user and an attributor of a native ad share similar demographics, e.g., belonging to the same age group, may also be a relevant factor in identifying an appropriate native ad with description that may be more appealing to the current user.

The user affinity identifier 1010, in this illustrated embodiment, takes the identification of the user to whom the ad is to be served as input and identifies the affinity, in one or more dimensions as disclosed above, between the current user and each of the attributors to the user curated native ads associated with the particular original ad. The affinity may be identified via information accessible from various sources such as social networks, user profiles (not shown), or any other sources that provide relevant information that is useful in determining affinities between the current user and attributors of the native ads that are being considered. In FIG. 10, the affinity information archive 1050 denotes a collection of information from, e.g., multiple sources, including social networks that records relationships among users active on the network, profiles of such active users, etc. Once the affinity in various dimensions is identified, the user affinity identifier 1010 may also rank the pairs of the original ad and each of the user native ads associated with the original ad and provides such information to the user curated native ad determiner 1040. In this manner, the semantic relevance as well as the affinity between a consumer of a user native ad and an attributor of the user native ad are considered in combination in selecting the most appropriate user native ad for the given original ad.

Other features may also be considered such as the quality of a user native ad (not shown in FIG. 10). For instance, if a user native ad is in text, the quality of the textual description from the attributor may be assessed with respect to grammar, spelling, and length of the text. If a user native ad is in a visual representation, the quality may be assessed based on visual effect, such as whether the imagery is vague or not or whether there is an image at all. If a user native ad is in an audio form, the quality may be assessed based on features that measure, e.g., pitch, speed of the speech, or ease of understanding the audio in terms of whether it is possible to recognize what is being said.

The user curated native ad determiner 1040 may also retrieve information from the user native ad performance database 660, in which the information about the past performance of each user native ad as well as a prediction of its future performance is stored. Intuitively, the better the past performance, the better it is. Similarly, a better prediction as to future performance also adds weights to a user native ad as to its suitability to be selected for use in connection with the given original ad.

The user curated native ad determiner 1040 integrates information from different sources, whether relevance between the original ad and the native ads, the affinity between the user to be displayed with the ad (either original or user native ad) and the attributor of a corresponding user native ad, and the performance related information, and makes a determination as to which user native is selected with respect to the particular original ad. The selected user native ad is then sent to the enhanced ad selection controller 330 (FIG. 3). Such a selection of a user curated native ad to be used with respect to the given original ad is also recorded by the user curated native ad determiner 1040 in the native ad use log 670.

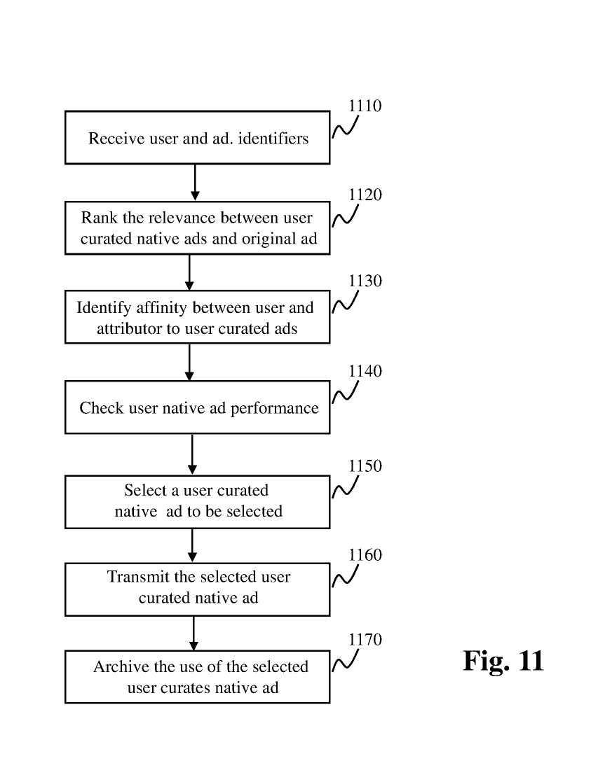

FIG. 11 is a flowchart of an exemplary process of the user native ad selector 610, according to an embodiment of the present teaching. Information related to an original ad selected to be displayed to a user is received at 1110. In some embodiments, the information related to the user is also received with the information about the original ad. To select a user native ad from a plurality of user native ads curated with respect to the original ad, the relevance between the original ad and each of the user native ads associated with the original ad is ranked at 1120. In addition, the affinity between the user and the attributor of each of the associated native ads is also assessed at 1130. Other assessment may also be made such as the quality of the user native ad itself (not shown in FIG. 11) and such assessed information from different perspectives is used by the user curated native ad determiner. In addition, performance information related to each user native ad being considered is also used at 1140 in selecting the most suitable user native ad. At 1150, a user native ad is selected, in consideration of assessment of various factors. The selected user native ad is then transmitted at 1160 in response to the request for a user native ad. The determination and use of the selected user native ad is then recorded at 1170.

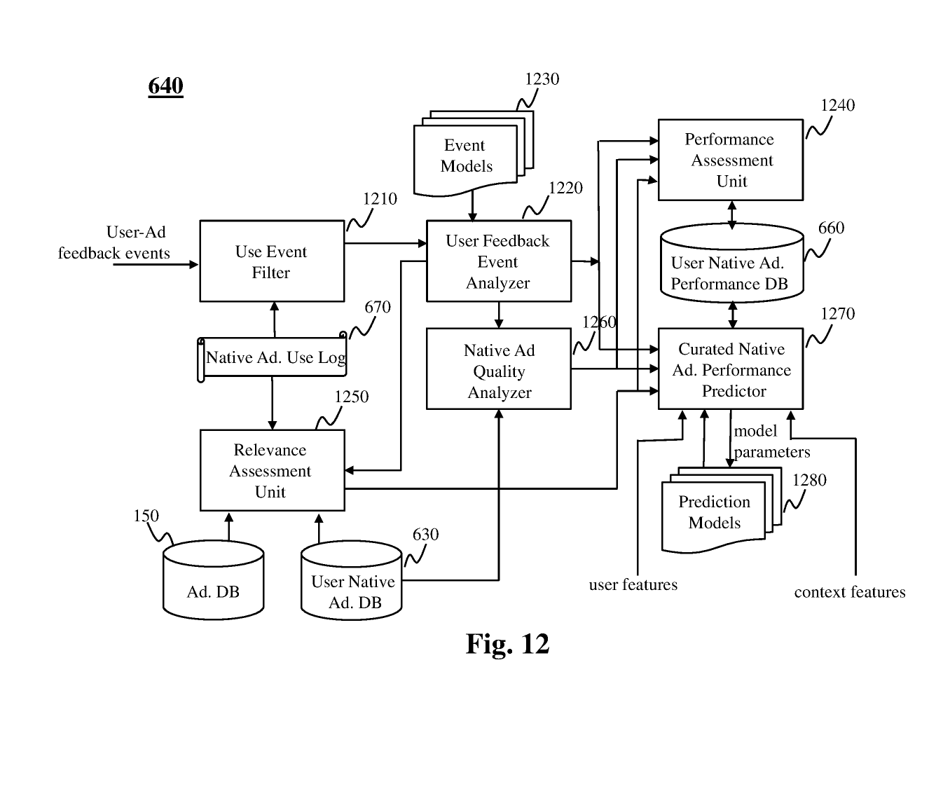

FIG. 12 depicts an exemplary high level system diagram of the user native ad performance evaluator 640, according to an embodiment of the present teaching. The user native ad performance evaluator 640 is for assessment the performance of some or each user native ad archived. It may also be designed to predict future performance based on statistics collected based on the usage of each user native ad. Such statistics may include the frequency that a user native ad is used and the outcome it may have led to (e.g., click-through rate, dwell time, or even conversion). In the illustrated embodiment presented in FIG. 12, the user native ad performance evaluator 640 comprises a use event filter 1210, a user feedback event analyzer 1220, a relevance assessment unit 1250, a native ad quality analyzer 1260, a performance assessment unit 1240, and a curated native ad performance predictor 1270.

The use event filter 1210 is for filtering out certain user feedback event that may not be significant enough to trigger the evaluation. Each user feedback event may be filtered against a specific usage recorded in the native ad use log 670. For example, if a user is presented a web page with a user native ad inserted therein. If the user feedback event is simply a click on the window to close down the browser, this event may not be significant enough to trigger performance evaluation because closing the browser does not necessarily mean that the user is disinterested in the content displayed. Alternatively, if the user feedback event is a click on the displayed user native ad in conjunction with a dwell time, then the use event filter 1210 may retain the event as requiring further analysis as to its significance and sends to the user feedback event analyzer 1220.

When a user feedback event is considered requiring further analysis, the user feedback event analyzer 1220 check the event against various event models 1230 to assess, e.g., whether the event is significant to the performance assessment. In the event models 1230, various events may be defined in terms of their respective significance. For instance, a mouse over event may be defined as not as significant as a conversion event. The significance of the user feedback event may be forwarded to the performance assessment unit 1240 so that the performance of the user native ad in this round of offering can be assessed and used to update the performance record in the user native ad performance database 660.

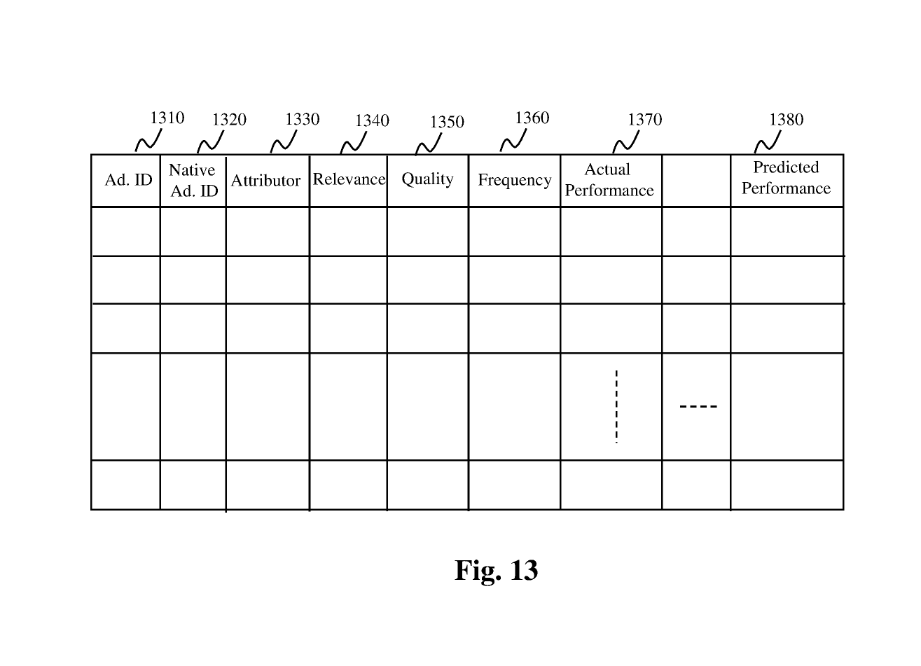

The performance assessment unit 1240 may access the past performance data stored in the user native ad performance database 660 and combine it with the current performance assessment to derive an updated actual performance recording. FIG. 13 shows an exemplary conceptual data structure for user native ads archive with performance information recorded in the user native ad performance database 660, according to an embodiment of the present teaching. In this exemplary illustration, each user curated native ad has a record (each row as an example) stored in the user native ad performance database 660. Each record may include information related to different aspects of a user native ad. In the illustrated example in FIG. 13, each row corresponds to a record for a user native ad with the identifier of the corresponding original ad 1310, the identifier of the user curated native ad 1320, attributor 1330, some assessment related to the curated native ad such as the relevance (1340) between the original ad and the user curate native ad as well as an assessment of the quality of the native ad (1350), some statistics on the usage of the user curated native ad such as the frequency 1360, performance-related information such as an assessment on the actual performance 1370 and a prediction of the estimated future performance prediction 1380, etc.

Data stored in the performance database 660 may be dynamically created and/or updated. For example, when a user native ad is curated, a new entry may be created in the exemplary data structure with an identifier assigned to the newly curated native ad and with its corresponding original ad identifier recorded as shown in FIG. 13. Information about the attributor of this native ad 1330 may also be recorded. The relevance between the native ad and the original ad or quality of the native ad, whenever assessed, may be stored in the same record (1340 and 1350) for future use. When a user native ad has been selected for use in conjunction with (or in place of) its corresponding original ad, information related to its use such as frequency may be updated (1360). When a user feedback event related to the use of the user native ad, the actual performance of the native ad may be evaluated and recorded in 1370 based on the nature of the feedback event. The future performance of the native ad may be estimated based on, e.g., the relevance, quality, and actual (past) performance of the native ad, and such a prediction may then be saved in 1380 so that it can be used in determining which user native ad is to be selected. Both the actual performance and the predicted performance (1370 and 1380) may be evaluated based on, e.g., the relevance 1340 and quality 1350 of the user native ad, as will be explained below. The predicted performance 1380 may be assessed also based on the recorded actual (past) performance 1370.

Whether to consider other types of information in assessing the performance or predicting future performance may depend on the analysis of the user feedback event, e.g., the significance of the event. The user feedback event analyzer 1220 may be configured to invoke different aspects of the evaluation based on the significance of the user feedback events. In some embodiments, it may activate, if the user feedback event is significant, the relevance assessment unit to evaluate the relevance between the original ad and the user curated native ad in consideration. It may also invoke, in some circumstances, the native ad quality analyzer 1260 to assess the performance of the user native ad in terms of its quality, whether the user native ad is text based, video based, image based, audio based, or a combination thereof. The evaluation of the quality of the user native ad may be implemented using any algorithm, existing or future developed, for assess the quality of a native ad in each of the modalities.

Similarly, the prediction of future performance of a user curated native ad may also be implemented to utilize different types of information and output prediction of different aspects of the performance. The curated native ad performance predictor 1270 may estimate a prediction of future performance by utilizing pre-configured prediction models 1280. Such models may be of any existing or future developed models, including statistical models, parameterized models, or any other models derived based on, e.g., offline training and/or online adaptation. There may be different aspects in predicting future performances and the curated native ad performance predictor 1270 can be configured to carry out predictions in different aspects. One aspect is to predict how a native ad will perform in the future based on the past actual performances. For example, if past performances have been good (e.g., led to click through or even conversions), the prediction of future performance can be accordingly estimated based on past performance information using the prediction models 1280. On the other hand, because the prediction models 1280 may be configured with parameters and such parameters impact the prediction of future performances, these parameters of the prediction models 1280 may be adapted via, e.g., offline training or dynamic online adjustment, based on past actual performances.

To predict future performance, the curated native ad performance predictor 1270 may access information stored in the user native ad performance database 660 such as relevance 1340 and/or quality 1350 for the estimation. The curated native ad performance predictor 1270 may also receive such assessment information directly from, e.g., the native ad quality analyzer 1260 and/or the relevance assessment unit 1250 that dynamically provide such assessment on-the-fly based on information that change over time (e.g., the user of a user native ad may change over time). Any other types of information may also be utilized to improve the quality of the prediction (not shown).

To adapt parameters of the prediction models 1280, the curated native ad performance predictor 1270 may use past performance information to adapt the parameters used by the prediction model 1280 and outputs a set of parameters to the prediction model 1280 so that such parameters may be used in the future for performance prediction. The curated native ad performance predictor 1270 may also be configured to adapt parameters in a context sensitive manner. For instance, it may adapt parameters with respect to user features or context features. For example, the system as disclosed herein may find that a particular native ad is effective for a particular group of users, e.g., in a certain region or of a certain age/gender group or who have clicked on curated ad before. For such a native ad, the prediction models may be adapted based on, e.g., features of users in this particular group so that the prediction models 1280 with such adapted parameters are more effective with respect to this particular group of users. With such individualized parameter sets, e.g., the curated native ad performance predictor 1270 may utilize the prediction models 1280 with a customized parameter set that is suitable for the situation.

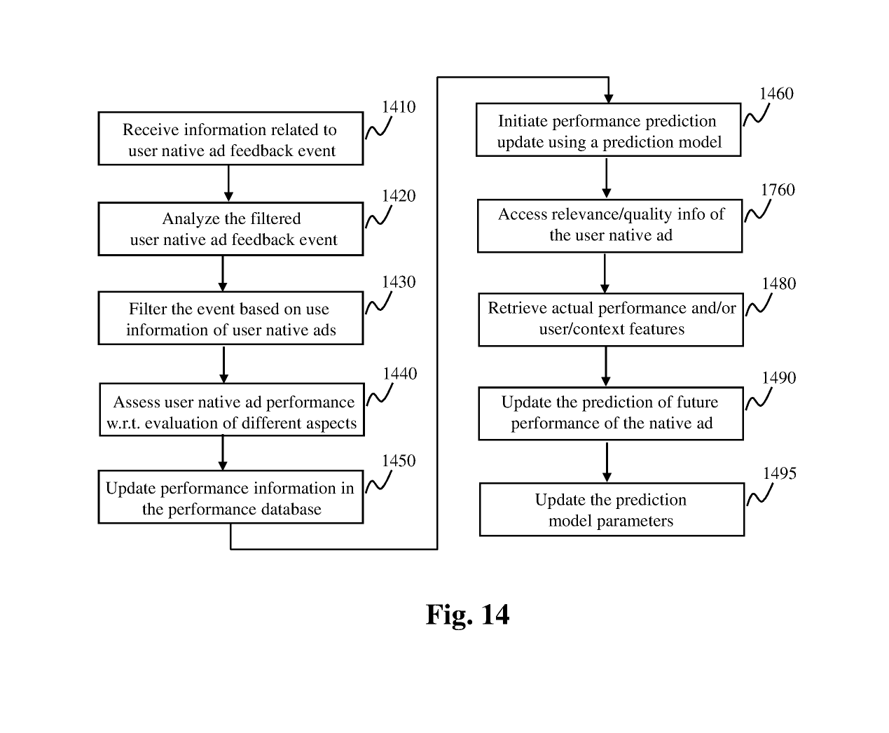

FIG. 14 is a flowchart of an exemplary process of the user native ad performance evaluator 640, according to an embodiment of the present teaching. Consistent with the disclosure related to FIG. 12, the evaluation of the performance of a user curated native ad may be triggered by a user feedback event. Such an event may be an action (e.g., click-through) or a lack of any action. To initiate the evaluation process, information related to a user feedback event associated with a user curated native ad is first received at 1410. The event may be analyzed at 1420. Based on the analysis of the event, the received user feedback event may be filtered, at 1430, which relates to a determination as to whether the event warrants proceeding with the evaluation. The determination may be performed for each user curated native ad as each user curated native ad may be configured differently as to when to trigger performance evaluation. For example, a user curated native ad may be configured to set forth the condition(s) under which the user curated native ad may be evaluated. Such conditions may be specified with respect to different feedback event(s). For instance, the performance evaluation may be carried out when the event is a concrete action performed on the user curated native ad instead of inaction. As another example, the condition may be set so that if the dwell time is below a certain threshold, no matter what event occurred, no performance evaluation is to be performed. Any event that does not satisfy the set condition, the event is filtered out and no evaluation of the performance is carried out.

When it is determined that performance evaluation is to be performed, the performance assessment unit 1240 carries out the performance assessment for the user curated ad at 1440. As discussed previously, the assessment may be based on evaluations with respect to various aspects of the user curated native ad, such as the quality of the native ad itself, the relevance between the native ad and the original ad, etc. Once the performance assessment is done, the performance information stored in the user native ad performance database 660 (1350 in FIG. 13) is updated at 1450.

With the performance information updated, the curated native ad performance predictor 1270 initiates, at 1460, the performance prediction based on a prediction model retrieved from 1280. As discussed above, the prediction may also be based on information related to different aspects of the native ad including the relevance, quality, as well as actual (past) performance. The relevance between the original ad and the native ad and quality information of the native ad may be accessed at 1470 (which may be either previously assessed or dynamically assessed by invoking related assessment functions). Similarly, assessment on the actual performance or past performance of the native ad is retrieved at 1480 for updating the prediction of future performance of the native ad. To adapt the parameters associated with the prediction models 1280, other information may also be obtained, such as user features and/or context features. Based on information of different dimensions related to different aspects of the curated native ad, the curated native ad performance predictor 1270 computes and updates the performance prediction, at 1490, stored in the user native ad performance database 660 (see 1380 in FIG. 13), based on a prediction model stored in 1280. The parameters of the prediction models 1280 are then adapted based on information related to past performance, user features, and/or context features and updated at 1495.

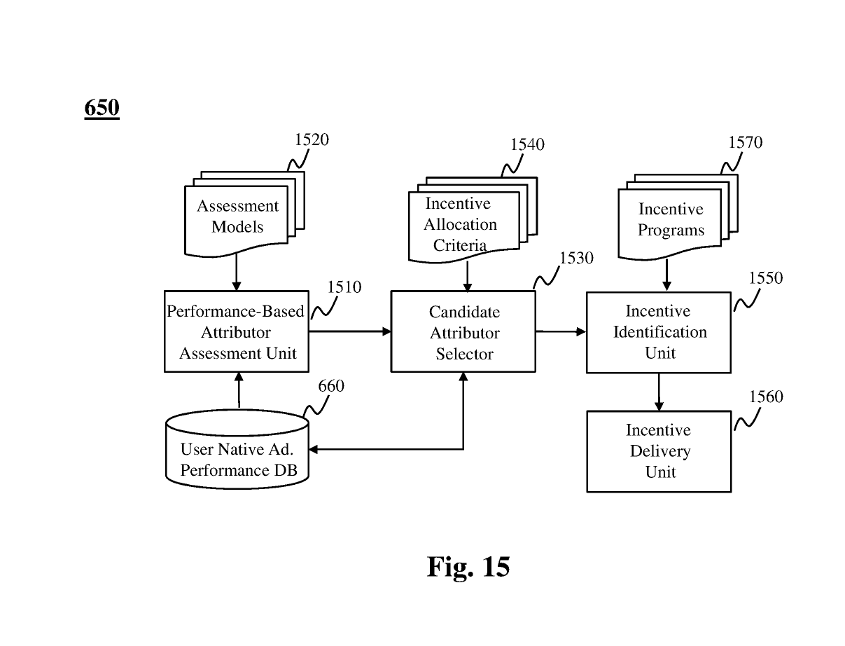

FIG. 15 depicts an exemplary high level system diagram of the user incentive allocator 650 (see FIG. 6), according to an embodiment of the present teaching. The user incentive allocator 650 is for providing incentives to attributors to user curated native ads based on the performance of such user curated native ads. The user incentive allocator 650 comprises a performance-based attributor assessment unit 1510, a candidate attributor selector 1530, an incentive identification unit 1550, and an incentive delivery unit 1560. In operation, the performance-based attributor assessment unit 1510 accesses information in the user native ad performance database 660 and evaluates each attributor who attributed native ads. Each attributor may contribute one or more native ads. The evaluation may be based on the performance of the native ads that each attributed contributed.

To assess the contribution of attributors, the performance-based attributor assessment unit 1510 retrieves configured assessment models stored in 1520 to guide the assessment. In some embodiment, an assessment model may be configured to assess the performance of an attributor based on the volume plus quality of the native ads that each attributor provided. In some embodiment, an assessment model may be configured to assess the contribution of an attributor based volume, relevance, and performance of the native ads that each attributor created. In other embodiments, the assessment model may instruct to rely on only performance and frequency of usage of the native ads. The assessment model 1520 may also set forth conditions by which some attributors will not be considered as candidates for getting an incentive. For example, the condition may be set that if a native ad has not been used or the frequency of use is below a threshold, the attributor of the native ad is not qualified to be considered.

Once assessed, the performance-based attributor assessment unit 1510 forward attributors that are subject to further consideration for incentive to the candidate attributor selector 1530, which is to select specific attributors for incentive allocation. To select some among a plurality of candidate attributors for incentives, the candidate attributor selector 1530 utilizes pre-determined incentive allocation criteria 1540. The criteria can be as simple as a number that limits the number of attributors that can receive an incentive. The criteria can also be group specific, e.g., each geographic region has a limited number of incentives to be delivered. The criteria may also be the level of performance required, e.g., a percentage of times that a presentation of a native ad leads to conversion. Such criteria may be dynamically re-configured or adapted according to situation.

Once attributors to whom incentives are to be provided are selected, the incentive identification unit 1550 accesses available incentives programs 1570 and for each selected attributor, an appropriate incentive is identified for each of the selected attributors. The appropriateness may be determined based on, e.g., geographical region, performance level, quality level, relevance level, and demographic information related to the selected attributor. The incentive delivery unit 1560 then delivers the incentive selected for each selected attributor to the attributor. The delivery can be electronic when the incentive is, e.g., a coupon or a subscription of electronic delivery of some online content. The delivery can also be made physical on incentives such as an electronic device, a book, or anything physical.

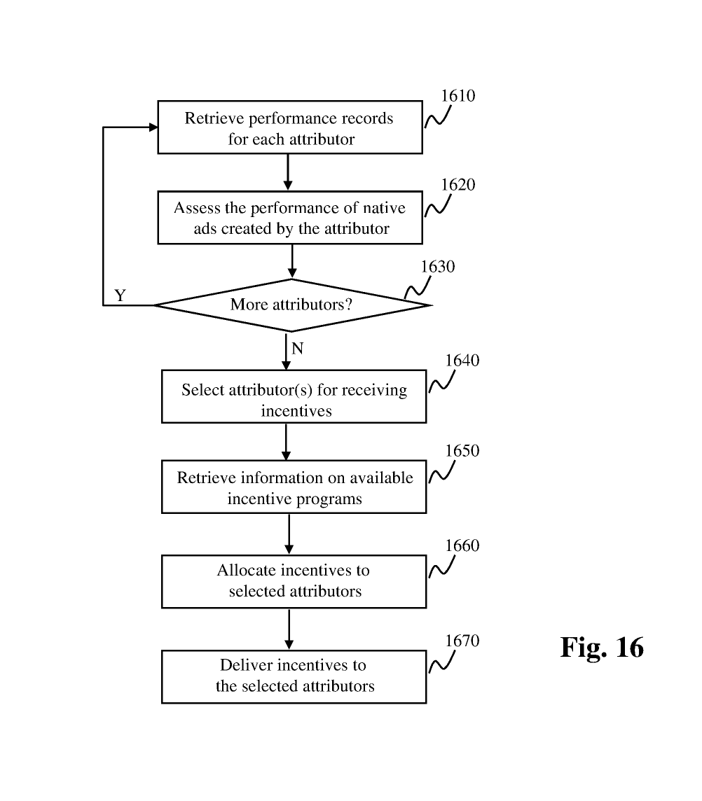

FIG. 16 is a flowchart of an exemplary process of the user incentive allocator 650 consistent with the disclosure above, according to an embodiment of the present teaching. To provide an incentive to some attributors of user created native ads, for each attributor, information related to the native ads that this attributor created is first accessed at 1610. Assess the attributor based on the performance of the native ads that the attributor created at 1620. The process continues until, determined at 1630, that all attributors are assessed based on the performance of the native ads that they created. Based on the assessment of all attributors, some attributors of native ads are selected, at 1640, for receiving incentives based on some pre-determined (but dynamically re-configurable) criteria. To allocate appropriate incentives to the selected attributors, information related to available incentive programs is retrieved at 1650. For each selected attributor, an appropriate incentive is selected given the available incentive programs to be allocated to the attributor at 1660. The allocated incentive for each selected attributor is then delivered, at 1670, to the attributor.

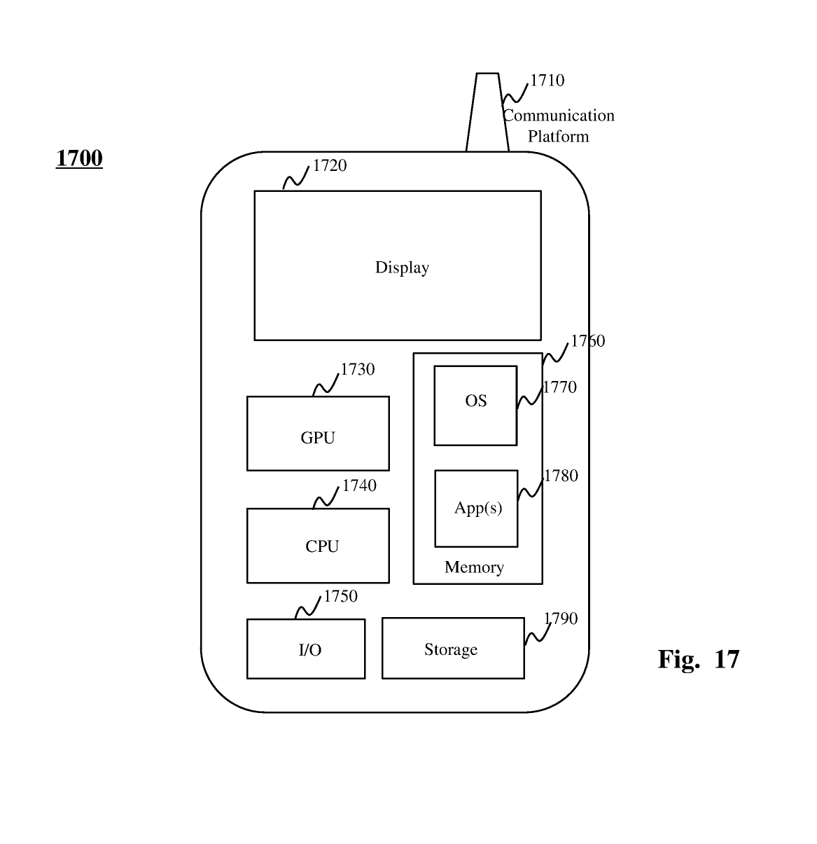

FIG. 17 depicts the architecture of a mobile device which can be used to realize a specialized system implementing the present teaching. In this example, the user device on which content and advertisement are presented and interacted-with is a mobile device 1700, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1700 in this example includes one or more central processing units (CPUs) 1740, one or more graphic processing units (GPUs) 1730, a display 1720, a memory 1760, a communication platform 1710, such as a wireless communication module, storage 1790, and one or more input/output (I/O) devices 1750. Any other suitable component, including but not limited to a system bus or a controller (not shown), may also be included in the mobile device 1500. As shown in FIG. 15, a mobile operating system 1770, e.g., iOS, Android, Windows Phone, etc., and one or more applications 1780 may be loaded into the memory 1760 from the storage 1790 in order to be executed by the CPU 1740. The applications 1780 may include a browser or any other suitable mobile apps for receiving and rendering content streams and advertisements on the mobile device 1700. User interactions with the content streams and advertisements may be achieved via the I/O devices 1750 and provided to the content provider 130 and/or the enhanced ad server 140 and/or other components of system 100, e.g., via the network 120.

To implement various modules, units, and their functionalities described in the present disclosure, computer hardware platforms may be used as the hardware platform(s) for one or more of the elements described herein (e.g., the content provider 130, the enhanced ad server 140 and/or other components of system 100 described with respect to FIGS. 1-16). The hardware elements, operating systems and programming languages of such computers are conventional in nature, and it is presumed that those skilled in the art are adequately familiar therewith to adapt those technologies to explore user curated native ads as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

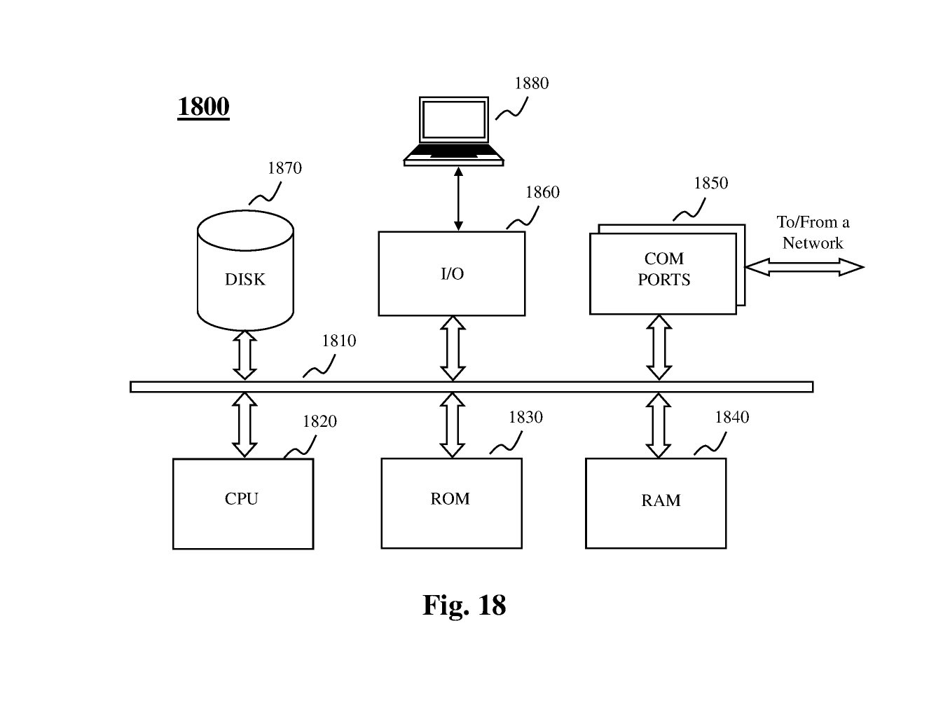

FIG. 18 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1800 may be used to implement any component of the enhanced ad server techniques, as described herein. For example, the enhanced ad server 140, etc., may be implemented on a computer such as computer 1800, via its hardware, software program, firmware, or a combination thereof. Although only one such computer is shown, for convenience, the computer functions relating to enhanced ad serving as described herein may be implemented in a distributed fashion on a number of similar platforms, to distribute the processing load.

The computer 1800, for example, includes COM ports 1850 connected to and from a network connected thereto to facilitate data communications. The computer 1800 also includes a central processing unit (CPU) 1820, in the form of one or more processors, for executing program instructions. The exemplary computer platform includes an internal communication bus 1810, program storage and data storage of different forms, e.g., disk 1870, read only memory (ROM) 1830, or random access memory (RAM) 1840, for various data files to be processed and/or communicated by the computer, as well as possibly program instructions to be executed by the CPU. The computer 1800 also includes an I/O component 1860, supporting input/output flows between the computer and other components therein such as user interface elements 1880. The computer 1800 may also receive programming and data via network communications.

Hence, aspects of the methods of enhancing ad serving and/or other processes, as outlined above, may be embodied in programming Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other enhanced ad server into the hardware platform(s) of a computing environment or other system implementing a computing environment or similar functionalities in connection with enhancing ad serving based on user curated native ads. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the enhanced ad serving based on user curated native ads as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform capable of connecting to a network for providing an advertisement, comprising:
receiving, via the communication platform, a request for an advertisement to be displayed to a user;
obtaining, by an enhanced advertisement server, an advertisement determined based the request and/or information related to the user;
receiving, by the enhanced advertisement server, information about an event involving the user and with respect to the advertisement displayed to the user; and
initiating, by the enhanced advertisement server, an action to explore at least one user curated native advertisement based on the information about an event.

2. The method of claim 1, wherein the advertisement is at least one of an original advertisement and a selected user curated native advertisement associated with the original advertisement.

3. The method of claim 2, wherein the selected user curated native advertisement is determined by a user native advertisement selector via:
retrieving one or more user curated native advertisements associated with the original advertisement;
assessing the one or more user curated native advertisements to determine the selected user curated native advertisement based on relevance between the original advertisement and each of the one or more user curated native advertisements.

4. The method of claim 3, further comprising:
determining an attributor of each of the one or more user curated native advertisements;
determining an affinity between the user and the attributor of each of the one or more user curated native advertisements;
ranking the affinities between the user and the attributors of the one or more user curated native advertisements; and
providing the affinities between the user and the attributors so that the affinities can be used in the step of assessing in determining the selected user curated native advertisement.

5. The method of claim 2, further comprising curating user native advertisements by a user native advertisement curator by:
soliciting, when the advertisement is the original advertisement, from the user a native advertisement with respect to the original advertisement;
receiving an input from the user in response to the soliciting;
storing the input from the user as a user curated native advertisement related to the original advertisement.

6. The method of claim 2, further comprising assessing, by a user native advertisement performance evaluator, the performance of the selected user curated native advertisement based on at least one of information about the event, the relevance between the selected user curated native advertisement and the original advertisement, and the quality of the selected user curated native advertisement.

7. The method of claim 2, further comprising providing, by a user incentive allocator, an incentive to an attributor to at least one user curated native advertisement, wherein the step of providing an incentive comprises:
retrieving information related to the performance of each of the one or more user curated native advertisements;
selecting the attributor to receive the incentive based on the information related to the performance;
allocating the incentive to the selected attributor; and
delivering the incentive to the attributor.

8. A system for providing an advertisement, comprising:
an enhanced ad selection controller connecting to a network and configured for receiving via the network a request for an advertisement to be displayed to a user;
a selector coupled with the enhanced ad selection controller and configured for obtaining an advertisement determined based the request;
a user curated native ad explorer, coupled with the enhanced ad selection controller and configured for receiving information about an event involving the user and with respect to the advertisement displayed to the user and initiating an action to explore user curated native advertisement based on the information about an event.

9. The system of claim 8, wherein the selector comprises:
an ad selector configured for selecting an original advertisement based on the request; and
the user curated native ad explorer configured for determining a selected user curated native advertisement associated with the original ad.

10. The system of claim 8, wherein the user curated native ad explorer comprises:
a user native ad curator configured for curating a plurality of user native advertisements; and
a user native ad selector configured for identifying, from the plurality of user native advertisements, a selected user curated native advertisement associated with an original advertisement selected to be presented to a user.

11. The system of claim 10, wherein the user native ad curator comprises:
a curation triggering unit configured for determining when to solicit a native advertisement related to an original advertisement from a user based on an event of the user occurred in connection with the original advertisement;
a native ad curation controller configured for soliciting the user native advertisement from the user; and
a user native ad archiver configured for archiving the solicited user native advertisement.

12. The system of claim 10, wherein the user native ad selector comprises a user curated native ad determiner configured for selecting a user curated native advertisement from one or more user native advertisements associated with the original advertisement based on at least one criterion.

13. The system of claim 12, wherein the at least criterion includes at least one of relevance between the original advertisement and the one or more user native advertisements associated with the original advertisement, performance of the one or more user native advertisements, and affinities between the user and at least one attributor that create the one or more user native advertisements.

14. The system of claim 10, further comprising:
a user native ad performance evaluator configured for assessing performance of the plurality of user native advertisements based at least partially on information related to an event related to the user occurred with respect to the selected user curated native advertisement after it being displayed to the user; or a user incentive allocator configured for providing an incentive to one or more attributors to the plurality of user native advertisements based at least partially on performance of the plurality of user native advertisements.

15. A machine-readable, non-transitory and tangible medium having data recorded thereon for providing an advertisement, the medium, when read by the machine, causes the machine to perform the following:
receiving, via a communication platform, a request for an advertisement to be displayed to a user;
obtaining an advertisement determined based the request and/or information related to the user;
receiving information about an event involving the user and with respect to the advertisement displayed to the user; and
initiating an action to explore at least one user curated native advertisement based on the information about an event.

16. The medium of claim 15, wherein the advertisement is at least one of an original advertisement and a selected user curated native advertisement associated with the original advertisement.

17. The medium of claim 16, wherein the selected user curated native advertisement is determined via:
retrieving one or more user curated native advertisements associated with the original advertisement;
assessing the one or more user curated native advertisements to determine the selected user curated native advertisement based on relevance between the original advertisement and each of the one or more user curated native advertisements.

18. The medium of claim 16, further comprising curating a plurality of user native advertisements by:
soliciting, when the advertisement displayed to the user is the original advertisement, from the user a user native advertisement with respect to the original advertisement;
receiving an input from the user in response to the soliciting; and
storing the input from the user as the user native advertisement related to the advertisement.

19. The medium of claim 16, further comprising assessing the performance of the selected user curated native advertisement based on at least one of the information about the event, relevance between the selected user curated native advertisement and the original advertisement, and quality of the selected user curated native advertisement.

20. The medium of claim 16, further comprising providing an incentive to an attributor to one or more user curated native advertisements, wherein the step of providing an incentive comprises:
retrieving information related to the performance of the one or more user curated native advertisements;
determining whether the attributor is to receive an incentive based on the information related to the performance;
allocating an incentive to the attributor; and
delivering the incentive to the attributor.
